(19) United States
(12) Patent Application Publication
(10) Pub. No.: US 2021/0004733 A1
(43) Pub. Date: Jan. 7, 2021

(54) AUTOMATED ITINERARY MANAGEMENT

(71) Applicant: AMERICAN EXPRESS TRAVEL RELATED SERVICES COMPANY, INC., New York, NY (US)

(72) Inventors: Mikhail R. Badua, New York, NY (US); Matthew Stephen Bodell, New York, NY (US); Alexandra Nicole Corey, Staten Island, NY (US); Teobaldo A. Fernandez, Gillette, NJ (US); Philip Norman, Brooklyn, NY (US)

(73) Assignee: AMERICAN EXPRESS TRAVEL RELATED SERVICES COMPANY, INC., New York, NY (US)

(21) Appl. No.: 16/502,390

(22) Filed: Jul. 3, 2019

(51) Int. Cl. G06Q 10/02; G06Q 50/14; G06Q 30/06

(52) U.S. Cl. CPC G06Q 10/025; G06Q 30/0631; G06Q 50/14

(57) ABSTRACT

Systems and methods for automated travel itinerary management are disclosed. The system may generate an automated itinerary based on travel-related transactions from a user's transaction account. The system may update the automated itinerary as additional travel-related transactions are completed. The system may also include travel data from travel systems, concierge systems, and manual input in the automated itinerary.

### FIELD

The present disclosure relates to travel itineraries, and more specifically, to systems and methods for automated itinerary management using transaction data.

### BACKGROUND

Various processes exist to allow users to organize travel plans. For example, a user may plan and organize travel plans by creating an itinerary. The user may generate an itinerary manually or by using itinerary management software. Itinerary management software may manage flight schedules, hotel bookings, rental car bookings, and the like. Users may manually input flight, hotel, and/or rental car information into the itinerary management system to populate a digital itinerary. The itinerary management software may also rely on email scraping (or similar text-based processing techniques) to identify travel data from the user's email accounts or provided physical documentation, and to populate the digital itinerary.

A technical problem is that the itinerary management software needs manual input and does not have access to real-time data needed to update the digital itinerary in real time, or near real time. As a result, users may not be aware of flight delays or cancellations, hotel and rental car cancellations, or similar travel problems as the travel problems are occurring. Instead, the user may need to navigate to separate websites, platforms, and travel information repositories to discover the full extent of the travel problem.

### SUMMARY

Systems, methods, and articles of manufacture (collectively, the “system”) for automated travel itinerary planning are disclosed. The system may receive an itinerary generation event comprising instructions to generate an automated itinerary for a user itinerary account, wherein the user itinerary account is associated with a user transaction account. The system may retrieve transaction data from the user transaction account, wherein the transaction data is associated with a travel-based transaction. The system may generate the automated itinerary to comprise the transaction data associated with the travel-based transaction.

In various embodiments, the system may retrieve travel system travel data and/or concierge travel data. The system may generate the automated itinerary to comprise the travel system travel data and/or the concierge travel data. The system may receive a travel data input comprising a manual input of travel data. The system may generate the automated itinerary to comprise the travel data input. The system may receive an itinerary update event comprising instructions to update the automated itinerary. The system may retrieve updated transaction data from the user transaction account, wherein the updated transaction data is associated with a second travel-based transaction made after the travel-based transaction. The system may update the automated itinerary to comprise the updated transaction data. The system may retrieve updated travel system travel data and/or updated concierge travel data. The system may update the automated itinerary to comprise the updated travel system travel data and/or the updated concierge travel data. The system may receive an updated travel data input comprising a second manual input of travel data. The system may update the automated itinerary to comprise the updated travel data input.

In various embodiments, the system may receive a user content submission, wherein the user content submission comprises at least one of an image or a user comment. The system may update the automated itinerary to comprise the user content submission. The system may receive an expense reimbursement request, wherein the expense reimbursement request comprises a reimbursement value based on the transaction data and a second user. The system may transmit the expense reimbursement request to the second user.

In various embodiments, the system may compare the automated itinerary to a second automated itinerary. The system may generate a profile score based on the comparing. The system may generate a suggested travel itinerary based on the profile score.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 is a block diagram illustrating a system for automated itinerary management, in accordance with various embodiments;

FIG. 2 illustrates a process flow for establishing a user itinerary account, in accordance with various embodiments;

FIG. 3 illustrates a process flow for generating an automated itinerary, in accordance with various embodiments;

FIG. 4 illustrates a process flow for updating an automated itinerary, in accordance with various embodiments;

FIG. 5 illustrates a process flow for interacting with past automated itineraries, in accordance with various embodiments; and

FIG. 6 illustrates a process flow for calculating a profile score for use in automated itineraries, in accordance with various embodiments.

### DETAILED DESCRIPTION

Systems and methods for automated itinerary management are disclosed. In various embodiments, the system may enable the generation of automated itineraries based at least partially on a user's purchases and transaction data. A user may enroll in a user itinerary account with the system. The user may link one or more transaction accounts to the user itinerary account. The system may retrieve travel-related transaction data and user profile data from the user's transaction account to generate the automated itinerary. The travel-related transaction data may comprise data associated with past, present, and upcoming travel-related transactions (e.g., flights, hotels, trains, cars, dining, entertainment, etc.).

In various embodiments, the user may also manually input travel data into the user itinerary account. For example, the travel data may be manually input by the user transmitting a digital image of a receipt, travel document, or the like to the system. The travel data may also be manually input by the user using a keyboard or similar input device. The user may also link one or more travel accounts to the user itinerary account. For example, the user may establish a travel account with an airline, a hotel, a rental car agency, a travel booking platform, and/or the like. The system may retrieve the travel data from the travel accounts. For example, the system may be in communication with the travel booking platform via an application programming interface (API), and/or through any other communication means. A server may respond to the travel data request. The user may also link one or more email addresses to the user itinerary account, and grant the system access to the email using email scraping or any other suitable text-based processing technique. For example, the system may have unrestricted access to the user's email account and may process the emails using any suitable text-based processing technique.

The system may combine the transaction data and travel data to generate the automated itinerary. The system may combine multiple types of data by determining whether all transactions made are booked on one confirmation number. If multiple bookings are made, the system may separate the bookings into separate travel plans. Therefore, the system may be able to determine whether a flight is part of one travel plan. For example, if the system determines from transaction data that a user bought a flight to Greece, and the system also determines that the same user has a flight scheduled to Germany immediately after Greece, the system will know the trips are separate based on the different confirmation number for each trip. Therefore, the automated itinerary may comprise real-time, or near real-time, travel information to provide the user an accurate and up-to-date itinerary to view pre-travel, during travel, and/or post-travel. In that regard, the system provides technical solutions to the technical problems found in typical itinerary management systems that require manual input and do not have access to real-time, or near real-time, travel data.

In various embodiments, the system may provide the user with expense tracking through a consolidated view of transactions from the automated itinerary. In that regard, the system may allow the user to view the expense tracking and transmit expense reimbursement requests to third parties, such as, for example, friends and family that joined in the travel, the user's place of work (e.g., a business trip), and/or any other desired third party individual or entity.

The system further improves the functioning of the computer. For example, by providing users the automated itinerary comprising real-time, or near real-time, travel data, the user may not need to manually navigate to separate websites, platforms, and travel information repositories. As a result, the user performs less computer functions and provides less input compared to typical itinerary management systems, which saves on data storage and memory which speeds processing. By retrieving data from multiple sources (e.g., transaction account website, airline website, hotel booking website, email, etc.), the system may decrease the number of websites, platforms, and travel information repositories that the user may interact with in order to engage in itinerary management. Data sources may be accessed in real time, or near real time. Additionally, by transmitting, storing, and accessing data using the processes described herein, the security of the data is improved, which decreases the risk of the computer or network from being compromised. For example, by automating the retrieval of transaction data, travel data, and similar sources of sensitive data, the system may decrease the need for user's to submit or upload travel data comprising sensitive information. Decreasing the need for user's to submit sensitive data may improve the security of the sensitive data, and may decrease the potential for security breaches, phishing attacks, and the like.

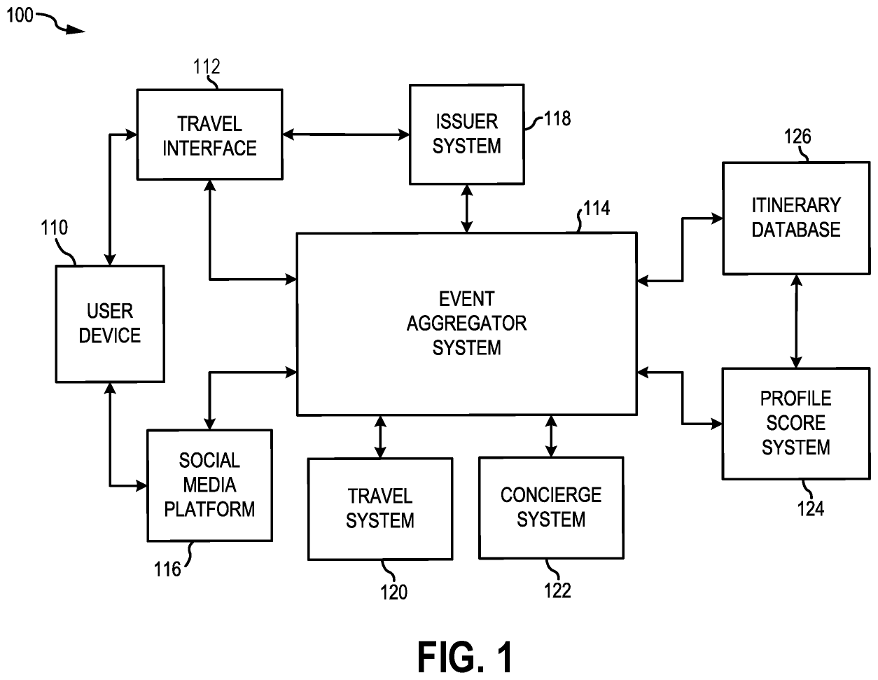

In various embodiments, and with reference to FIG. 1, a system 100 for automated travel management is disclosed. System 100 may comprise a user device 110, a travel interface 112, an event aggregator system 114, a social media platform 116, an issuer system 118, a travel system 120, a concierge system 122, a profile score system 124, and/or an itinerary database 126. System 100 may also contemplate uses in association with web services, utility computing, pervasive and individualized computing, security and identity solutions, autonomic computing, cloud computing, commodity computing, mobility and wireless solutions, open source, biometrics, grid computing, and/or mesh computing.

In various embodiments, user device 110 may be configured to enable a user to access and interact with system 100 to generate and view automated itineraries, as discussed further herein. User device 110 may be in electronic communication with travel interface 112 and/or social media platform 116. User device 110 may comprise one or more hardware, software, and/or database components capable of sending, receiving, and storing data. For example, user device 110 may comprise a personal computer, personal digital assistant, cellular phone, smartphone (e.g., IPHONE®, BLACKBERRY®, and/or the like), Internet of Things (IoT) device, and/or the like. User device 110 may comprise an operating system such as, for example, a WINDOWS® mobile operating system, an ANDROID® operating system, APPLE® IOS®, a BLACKBERRY® operating system, a LINUX® operating system, and the like. User device 110 may also comprise software components installed on user device 110 and configured to allow a user access to various systems, services, and components in system 100. For example, user device 110 may comprise a web browser (e.g., MICROSOFT INTERNET EXPLORER®, GOOGLE CHROME®, etc.), an application, a micro-app or mobile application, and/or the like configured to allow user device 110 access to various systems, services, and components in system 100.

User device 110 may also comprise location service configured to detect the geographic location of user device 110. For example, user device 110 may comprise a global positioning system (GPS) and/or any other hardware or software configured to provide location data.

In various embodiments, a user, via user device 110, may access travel interface 112 to interact with various components of system 100, such as, for example, event aggregator system 114 and/or issuer system 118. For example, user device 110 may communicate with travel interface 112 to register the user for a user itinerary account, generate an automated itinerary, interact with an automated itinerary, and/or the like, as discussed further herein. Travel interface 112 may be in electronic communication with user device 110, event aggregator system 114, and/or issuer system 118. Travel interface 112 may comprise a web-based interface and may include a graphical user interface (“GUI”), software modules, logic engines, various databases, interfaces to systems and tools, and/or computer networks. Travel interface 112 may be accessible via a web browser, such as, for example, MICROSOFT INTERNET EXPLORER®, GOOGLE CHROME®, MOZILLA FIREFOX®, and/or any other suitable or desired web browser. Travel interface 112 may also be accessible via a mobile application, software application, or the like.

In various embodiments, event aggregator system 114 may be configured generate automated itineraries. As discussed further herein, event aggregator system 114 may be configured to retrieve travel-related data from various data sources such as, for example, travel interface 112, social media platform 116, issuer system 118, travel system 120, concierge system 122, and/or the like. Event aggregator system 114 may generate the automated itinerary based on the retrieved travel-related data. Event aggregator system 114 may communicate with itinerary database 126 to store the travel-related data and/or the automated itinerary.

Event aggregator system 114 may be in electronic communication with travel interface 112, social media platform 116, issuer system 118, travel system 120, concierge system 122, profile score system 124, and/or itinerary database 126. Event aggregator system 114 may comprise one or more hardware, software, and/or database components. For example, event aggregator system 114 may comprise one or more network environments, servers, computer-based systems, processors, databases, and/or the like. Event aggregator system 114 may comprise at least one computing device in the form of a computer or processor, or a set of computers/processors, although other types of computing units or systems may be used such as, for example, a server, web server, pooled servers, or the like. In various embodiments, event aggregator system 114 may include one or more processors and/or one or more tangible, non-transitory memories and be capable of implementing logic. The processor may be configured to implement various logical operations in response to execution of instructions, for example, instructions stored on a non-transitory, tangible, computer-readable medium, as discussed further herein. In various embodiments, event aggregator system 114, itinerary database 126, and/or profile score system 124 may comprise virtual or logical partitions of a single system or group of systems. In various embodiments, event aggregator system 114, itinerary database 126, and/or profile score system 124 may comprise separate systems.

In various embodiments, social media platform 116 may comprise any suitable social media platform, website, mobile application or the like. For example, exemplary social media platforms may include FACEBOOK®, INSTAGRAM®, LINKEDIN®, PINTEREST®, QZONE®, SNAPCHAT®, TWITTER®, VKontakte (VK), etc. Social media platform 116 may comprise various hardware, software, and/or database components. In various embodiments, a user may link the user's social media account on social media platform 116 with the user itinerary account, via travel interface 112. For example, the user may interact with travel interface 112 to post an automated itinerary to the user's social media account on social media platform 116. As a further example, the user may interact with social media platform 116 to transmit travel-related photos, videos, etc. to travel interface 112 to be included in an automated itinerary.

In various embodiments, issuer system 118 may be in electronic communication with travel interface 112 and/or event aggregator system 114. Issuer system 118 may include any entity that offers transaction account services, such as, for example, any type of bank, lender, or other type of account issuing institution, such as transaction account companies, card sponsoring companies, or third-party issuers under contract with issuer system 118. In various embodiments, issuer system 118 may comprise an exemplary transaction account issuer and/or transaction network such as AMERICAN EXPRESS®, VISANET®, MASTERCARD®, DISCOVER®, INTERAC®, Cartes Bancaires, JCBR, private networks (e.g., department store networks), and/or any other payment network, transaction network, issuer system, or the like. Issuer system 118 may comprise a sub-network, computer-based system, software component, and/or the like configured to provide an access point to various systems, engines, servers, and components for a given transaction account issuer.

Issuer system 118 may comprise one or more hardware, software, and/or database components. For example, issuer system 118 may comprise one or more network environments, servers, computer-based systems, processors, databases, and/or the like. Issuer system 118 may comprise at least one computing device in the form of a computer or processor, or a set of computers/processors, although other types of computing units or systems may be used such as, for example, a server, web server, pooled servers, or the like. Issuer system 118 may also include software, such as services, APIs, and the like, configured to perform various operations discussed herein. In various embodiments, issuer system 118 may include one or more processors and/or one or more tangible, non-transitory memories and be capable of implementing logic. The processor may be configured to implement various logical operations in response to execution of instructions, for example, instructions stored on a non-transitory, tangible, computer-readable medium, as discussed further herein.

Issuer system 118 may include subsystems, databases, and the like related to various financial systems and processes. For example, issuer system 118 may include one or more authorization engines, authentication engines and databases, settlement engines and databases, accounts receivable systems and databases, accounts payable systems and databases, and/or the like. In various embodiments, issuer system 118 may also comprise a transaction account issuer's Credit Authorization System (“CAS”) capable of authorizing transactions, as discussed further herein. Issuer system 118 may be configured to authorize and settle transactions, and maintain transaction account member databases, accounts receivable databases, accounts payable databases, or the like.

In various embodiments, issuer system 118 may control and/or comprise event aggregator system 114, concierge system 122, itinerary database 126, and/or profile score system 124. In that regard, issuer system 118, event aggregator system 114, concierge system 122, itinerary database 126, and/or profile score system 124 may comprise subcomponents (virtual or logical partitions) of a single, or set of, computer-based systems or networks.

Although the present disclosure makes reference to issuer system 118, it should be understood that principles of the present disclosure may be applied to a system for automated itinerary management having any suitable number of issuer systems. For example, system 100 may comprise one or more issuer systems 118, each corresponding to or associated with a different issuer system or transaction account issuer.

In various embodiments, event aggregator system 114 may be in communication with one or more travel systems 120. Each travel system 120 may comprise a provider of travel services, a travel booking platform, a travel information provider, or the like. For example, a travel system 120 may comprise a booking system or platform corresponding to a hotel, motel, bed and breakfast, hostel, or the like, such as those provided by HILTON HOTELS & RESORTS®, MARRIOTT®, WYNDHAM®, or the like. As a further example, a travel system 120 may comprise a booking system or platform for vacation rentals and short term properties, such as those provided by AIRBNB®, HOMEAWAY®, VRBO®, and/or the like. As a further example, a travel system 120 may comprise a booking system or platform corresponding to an airline, such as those offered by AMERICAN AIRLINES®, DELTA®, SOUTHWEST®, and/or the like. As a further example, a travel system 120 may comprise a booking system or platform for dining, entertainment, and hospitality, such as those offered by OPENTABLE®, YELP®, VenueLytics™, and/or the like. As a further example, a travel system 120 may comprise a booking system or platform corresponding to an aggregated travel booking system, such as those provided by EXPEDIA®, TRAVELOCITY®, ORBITZ®, and/or the like. As a further example, a travel system 120 may comprise a travel booking system or platform offered by issuer system 118, such as those provided by AMERICAN EXPRESS®, J.P. MORGAN CHASE BANK®, CAPITAL ONE®, and/or the like.

Travel system 120 may comprise various hardware, software, and/or database components configured to store and provide travel data. For example, the user may register with one or more travel systems 120 to create a user travel account. The user may interact with the travel system 120 to book travel (e.g., flights, hotels, rental cars, dining, entertainment, etc.). Travel system 120 may store the travel data related to the booked travel, and may associate the travel data with the user travel account. The user may provide the user travel account to event aggregator system 114, via travel interface 112. In that regard, event aggregator system 114 may communicate with travel system 120 to retrieve the travel data associated with the user travel account. The retrieved travel data may be used to populate or updated an automated itinerary, as discussed further herein.

In various embodiments, travel system 120 may comprise software (e.g., an API, software development kits (SDK), etc.) configured to provide travel data from various travel sources. For example, travel system 120 may comprise software offered by GOOGLE PLACES®, the International Air Transport Association (IATA), SABRE®, and/or the like.

In various embodiments, event aggregator system 114 may be in electronic communication with one or more concierge systems 122. Concierge systems 122 may be configured to interact with a user to book travel for the user, suggest travel for the user, answer travel related questions, and/or the like. Concierge systems 122 may comprise one or more hardware, software, and/or database components. A concierge system 122 may comprise a web-based interface, mobile application, or the like. In various embodiments, concierge system 122 may comprise a concierge system, platform, or interface offered by a travel system 120. In various embodiments, concierge system 122 may comprise a travel concierge system, platform, or interface offered by an issuer system 118.

In various embodiments, concierge system 122 may be configured to conduct automated textual or auditory conversations with users. For example, concierge system 122 may comprise a service powered by rules, machine learning, artificial intelligence, natural language processor (NLP), and/or the like, enabling a user to interact via a chat interface allowing multiple language support (e.g., English, French, Spanish, etc.). Concierge system 122 may comprise a talkbot, chatbot, chatterbox, artificial conversational entity, and/or the like capable of conducting an automated textual and/or auditory conversation with a user (e.g., via user device 110). Concierge system 122 may include any suitable chatbot, for example, MICROSOFT® CHATBOT™, CLARE.AI™ NANOREP™ TWYLA™, BOTSIFY™, MORPH.AI™, MANYCHAT™, CHATFUEL®, CONVERSABLE™, DIAGFLOW™ GUPSHUP®, etc.

In various embodiments, concierge system 122 may also be configured to provide contact information for a customer care professional representative (“CCP”), and/or may electronically connect the user (e.g., via user device 110) to the CCP via a chat interface, phone call, text message, email, or the like.

The user may interact with concierge system 122 to receive travel suggestions, to book travel, and/or the like. Concierge system 122 may generate the travel suggestions using any suitable technique. For example, concierge system 122 may generate a dining suggestion based on a user location (e.g., determined by location services on user device 110, an area of booked travel, etc.). For example, the user may perform a search for Italian cuisine in a particular location while on a trip. Concierge system 122 may populate a list of Italian restaurant suggestions in the specified location. As a further example, concierge system 122 may implement machine learning and/or artificial intelligence to determine travel suggestions. For example, concierge system 122 may utilize collaborative filtering methods to determine travel suggestions. Collaborative filtering methods may include user-based collaborative filtering. User-based collaborative filtering may refer to a method of making automatic predictions regarding user interests by gathering user preferences from a large sampling of users. The algorithm may compute a correlation similarity in a user-item ratings matrix of n integer rows associated with users or n integer columns associated with items. User-based similarity measures may include cosine, Pearson, Euclidean, and any other similarity measure capable of measuring user-based similarity. By computing user-based similarity of rows or columns, user-based collaborative filtering may recommend items that nearby users enjoyed, based on profile similarity to the user. By multiplying the corresponding row and column, the rating of the item by the user may be predicted.

As a further example, concierge system 122 may also utilize association rules to make recommendations for travel suggestions. Association rules may comprise analyzing data for patterns in a database and identifies frequent if-then associations. Association rules may comprise two components: an antecedent (if) and a consequent (then). The antecedent may be the item found within data. The consequent may be the item found in combination with the antecedent. Items (e.g., user spending) that may be frequently bought together may be connected. Based on items frequently purchased together, concierge system 122 may view clusters of most-visited locations (e.g., locations where many users interact) and small-separated clusters (e.g., locations for niche content based on user interest).

Concierge system 122 may next perform mainstream versus long tail analysis. As used herein, long tail analysis may refer to analysis of a statistical distribution of high-frequency items followed by low-frequency items which decrease or “tail off” asymptotically. Low-frequency items have a low probability of selection. By performing mainstream versus long tail analysis, the collaborative filtering algorithm utilized by concierge system 122 may intentionally penalize popular items in order to decrease potential popularity bias to prevent popular items being recommended more often than items in the long tail. For example, concierge system 122 may penalize a popular item, such as eating at a large chain restaurant.

In various embodiments, profile score system 124 may be in electronic communication with event aggregator system 114 and/or itinerary database 126. Profile score system 124 may comprise one or more hardware, software, and/or database components. For example, profile score system 124 may comprise one or more network environments, servers, computer-based systems, processors, databases, and/or the like. Profile score system 124 may comprise at least one computing device in the form of a computer or processor, or a set of computers/processors, although other types of computing units or systems may be used such as, for example, a server, web server, pooled servers, or the like. Profile score system 124 may also include software, such as services, APIs, and the like, configured to perform various operations discussed herein. In various embodiments, profile score system 124 may include one or more processors and/or one or more tangible, non-transitory memories and be capable of implementing logic. The processor may be configured to implement various logical operations in response to execution of instructions, for example, instructions stored on a non-transitory, tangible, computer-readable medium, as discussed further herein.

Profile score system 124 may be configured to generate a profile score for a user itinerary account. The profile score may comprise a comparison score indicating an at least partial match between the user itinerary account and a second user itinerary account. The profile score may be generated using any suitable technique, including, for example, machine learning. The machine learning may comprise collaborative filtering methods, as previously described herein. Profile score system 124 may compare items in the collaborative filtering method to generate the profile score (e.g., travel data from a large sample of user itinerary accounts, such as, for example, travel-related transaction data, travel system travel data, concierge travel data, travel data input, and/or the like, as discussed further herein). For example, the profile score may comprise a percent score that a user itinerary account has in common with a second user itinerary account. In that regard, the profile score may be used to provide recommendations to users that have similar interests or similar travel or spending patterns. For example, if a user is considering traveling to Paris for the first time, and has already traveled to multiple other locations that a second user has traveled to, profile score system 124 may determine a 90% match between the user and the second user. Based on the 90% match, profile score system 124 may offer the user travel suggestions from the second user's itinerary account.

In various embodiments, itinerary database 126 may be configured to store and maintain user itinerary account data, travel data, user content, automated itineraries, and/or the like. Itinerary database 126 may be in electronic communication with event aggregator system 114 and/or profile score system 124. Itinerary database 126 may comprise any suitable database, data structure, server, or the like capable of storing and maintaining data.

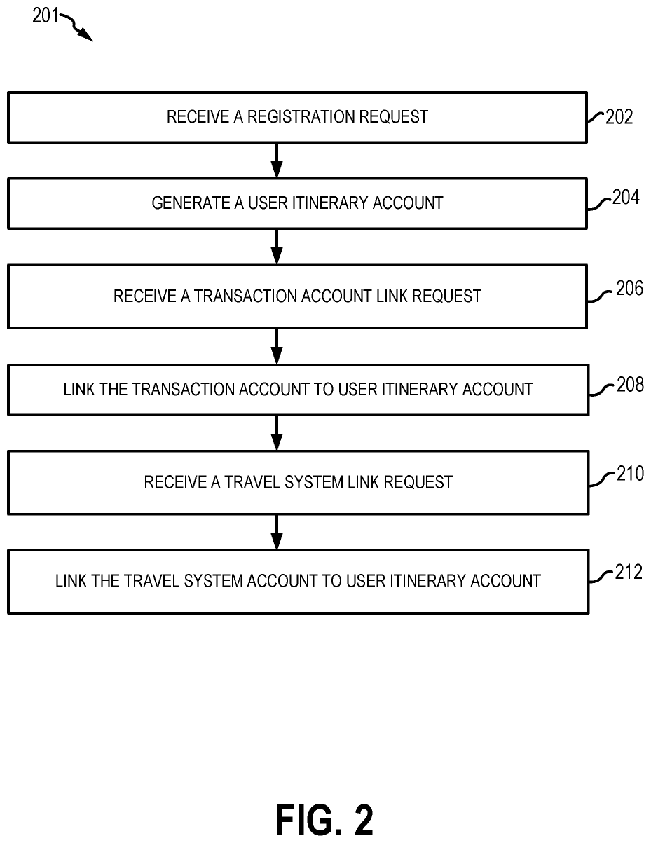

Referring now to FIGS. 2-6 the process flows depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and user interface elements depicted in FIGS. 2-6, but also to the various system components as described above with reference to FIG. 1. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below. Unless otherwise specifically noted, articles depicted in the drawings are not necessarily drawn to scale.

In various embodiments, and with specific reference to FIG. 2, a method 201 for establishing a user itinerary account is disclosed. The system may receive a registration request (step 202). For example, a user (e.g., via user device 110) may interact with travel interface 112 to submit the registration request. The registration request may comprise user identifying data, such as, for example, a username, a password, a biometric input, a knowledge based authentication (KBA), and/or the like. In response to receiving the registration request, travel interface 112 may transmit the registration request to event aggregator system 114.

The system may generate a user itinerary account (step 204). For example, in response to receiving the registration request, event aggregator system 114 may generate the user itinerary account. Event aggregator system 114 may generate the user itinerary account using any suitable process or technique. The user itinerary account may be assigned a unique identifier. In various embodiments, the unique identifier may comprise the username from the registration request. In response to generating the user itinerary account, event aggregator system 114 may transmit the user itinerary account to itinerary database 126 for storage.

The system may receive a transaction account link request (step 206). For example, the user (e.g., via user device 110) may input the transaction account link request into travel interface 112. The transaction account link request may comprise one or more transaction accounts that the user desires to link to the user itinerary account. The one or more transaction accounts may be identified by a transaction account identifier (e.g., an account number). In various embodiments, travel interface 112 may communicate with issuer system 118 to grant permission for the system to access the selected transaction accounts. For example, issuer system 118 may prompt the user, via travel interface 112, to input a user identifier associated with issuer system 118 (e.g., an issuer system user identifier). In response to verifying the user, issuer system 118 may grant the system access to the selected transaction account (e.g., access to retrieve travel-related transaction data). In various embodiments, event aggregator system 114 may preregister with issuer system 118 to authorize event aggregator system 114 to access the user data from issuer system 118. In various embodiments, travel interface 112 may display the available user transaction accounts based on the issuer system user identifier, and the transaction account link request may be generated in response to the user selecting the transaction accounts that the user desires to link to the user itinerary account. Travel interface 112 may transmit the transaction account link request to event aggregator system 114.

The system may link the transaction account to the user itinerary account (step 208). For example, in response to receiving the transaction account link request, event aggregator system 114 may transmit the transaction account identifier to itinerary database 126. The transaction account identifier may be stored in itinerary database 126 with the user itinerary account. In various embodiments, event aggregator system 114 may also communicate with issuer system 118 to grant permission for event aggregator system 114 to access the selected transaction accounts.

The system may receive a travel system link request (step 210). For example, the user (e.g., via user device 110) may input the travel system link request into travel interface 112. The travel system link request may comprise one or more travel systems 120 that the user wants to link to the user itinerary account. For example, the travel system link request may comprise a travel system user identifier that the user inputs to access the user's travel account on a particular travel system 120 (e.g., username, password, etc.). In that regard, the travel system link request may grant the system access to the user's travel account from a travel system 120 such that the system, via event aggregator system 114, may retrieve travel data associated with the user's travel account. Travel interface 112 may transmit the travel system link request to event aggregator system 114.

The system may link the travel system account to the user itinerary account (step 212). For example, in response to receiving the travel system link request, event aggregator system 114 may transmit the travel system user identifier to itinerary database 126. The travel system user identifier may be stored in itinerary database 126 with the user itinerary account. In various embodiments, event aggregator system 114 may also communicate with the corresponding travel system 120 to grant permission for event aggregator system 114 to access the selected user travel account.

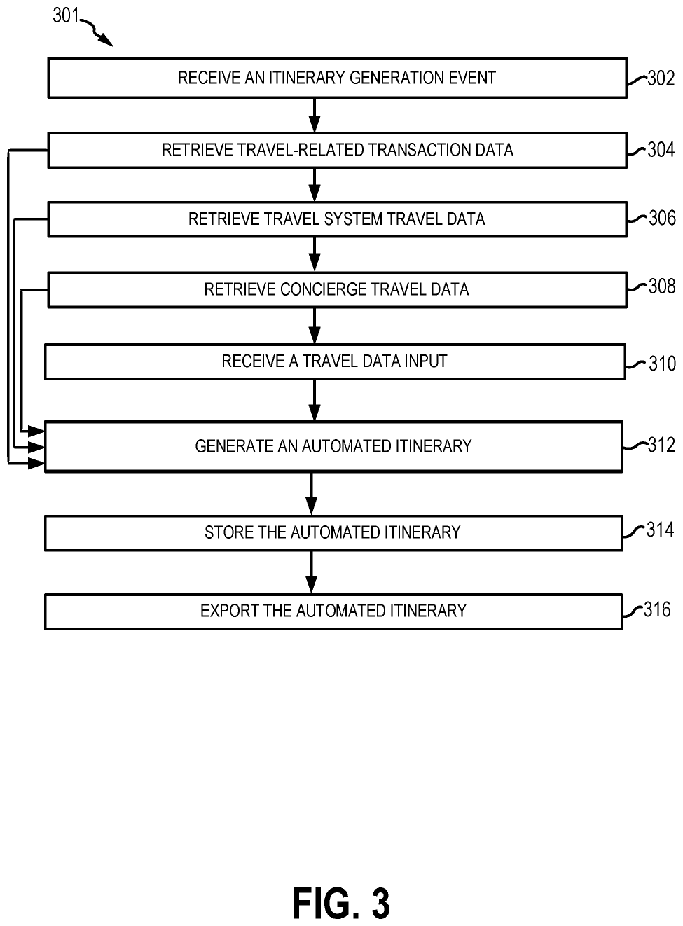

In various embodiments, and with specific reference FIG. 3, a method 301 for generating an automated itinerary is disclosed. The system may receive an itinerary generation event (step 302). Event aggregator system 114 may be configured to receive and/or detect the itinerary generation event. For example, the itinerary generation event may comprise a request from user device 110, via travel interface 112, to generate an automated itinerary. The request may comprise data regarding user travel, such as, for example, a travel time period, a travel data input (e.g., as discussed further in step 310), and/or the like. As a further example, in response to user device 110 accessing and/or interacting with travel interface 112, travel interface 112 may transmit the itinerary generation event to event aggregator system 114.

In various embodiments, in response to receiving (or detecting) the itinerary generation event, event aggregator system 114 may query itinerary database 126 to retrieve the user itinerary account associated with the user (e.g., based on user identifier). The system may retrieve travel-related transaction data (step 304). For example, event aggregator system 114 may communicate with issuer system 118 to retrieve travel-related transaction data based on the user itinerary account (e.g., the issuer system user identifier). Event aggregator system 114 may retrieve the travel-related transaction data based on a defined travel date range, based on a user location (e.g., obtained from user input or GPS data from user device 110), and/or the like. For example, and in accordance with various embodiments, issuer system 118 may separate travel-related transactions from other types of transactions using level 3 line item data (e.g., item description, product codes, etc.). A merchant may provide the line item data to issuer system 118 (e.g., either directly or via a third-party intermediary). Based on the line item data, non-travel-related transactions will not be received or retrieved by issuer system 118. Event aggregator system 114 may transmit the travel-related transaction data to itinerary database 126. Itinerary database 126 may store the travel-related transaction data with the user itinerary account.

The system may retrieve travel system travel data (step 306). Event aggregator system 114 may retrieve the travel system travel data from travel system 120, based on the user itinerary account (e.g., the travel system user identifier). Event aggregator system 114 may retrieve the travel system travel based on a user selection, a defined travel date range, and/or the like. Event aggregator system 114 may transmit the travel system travel data to itinerary database 126. Itinerary database 126 may store the travel system travel data with the user itinerary account.

The system may retrieve concierge travel data (step 308). Event aggregator system 114 may retrieve the concierge travel data from concierge system 122. The concierge travel data may comprise travel booking data generated by concierge system 122 in response to the user interacting with concierge system 122 to book travel. Event aggregator system 114 may transmit the concierge travel data to itinerary database 126. Itinerary database 126 may store the concierge travel data with the user itinerary account.

The system may receive a travel data input (step 310). Event aggregator system 114 may receive the travel data input from user device 110, via travel interface 112. The travel data input may comprise travel-related data manually input by the user, such as, for example, a digital image of a receipt, travel document of the like; a manual input of travel via a keyboard or similar input device; an email address available for email scraping; and/or the like. In various embodiments, event aggregator system 114 may implement natural language processing, optical character recognition (OCR) software, and/or the like configured to parse and identify the data from the travel data input. Event aggregator system 114 may transmit the parsed travel data input to itinerary database 126. Itinerary database 126 may store the parsed travel data input with the user itinerary account.

The system may generate an automated itinerary (step 312). Event aggregator system 114 may generate the automated itinerary based on one or more of the travel-related transaction data, the travel system travel data, the concierge travel data, and/or the travel data input. For example, event aggregator system 114 may query itinerary database 126 to retrieve the various travel data associated with the user itinerary account. Itinerary database 126 may organize the various travel data by time, date, trip, and/or any other method of organization. Event aggregator system 114 may generate the automated itinerary using any suitable process. For example, the automated itinerary may comprise the various travel data based on date range, specified trip, or the like. For example, the automated itinerary may comprise a trip timeline including the various travel data ordered sequentially.

The system may store the automated itinerary (step 314). Event aggregator system 114 may transmit the automated itinerary to itinerary database 126. Itinerary database 126 may store the automated itinerary with the user itinerary account. The system may export the automated itinerary (step 316). Event aggregator system 114 may export the automated itinerary into any suitable file format or presentation. For example, event aggregator system 114 may generate and export the automated itinerary as a word document, a .PDF document, an XML file, an image file (e.g., .JPG, .PNG, etc.) or the like. Event aggregator system 114 may also be configured to display the automated itinerary to user device 110, via travel interface 112. Event aggregator system 114 may also transmit the automated itinerary to user device 110 via text message, email, push notification, a provided URL, or the like. Event aggregator system 114 may also transmit the automated itinerary directly to social media platform 116.

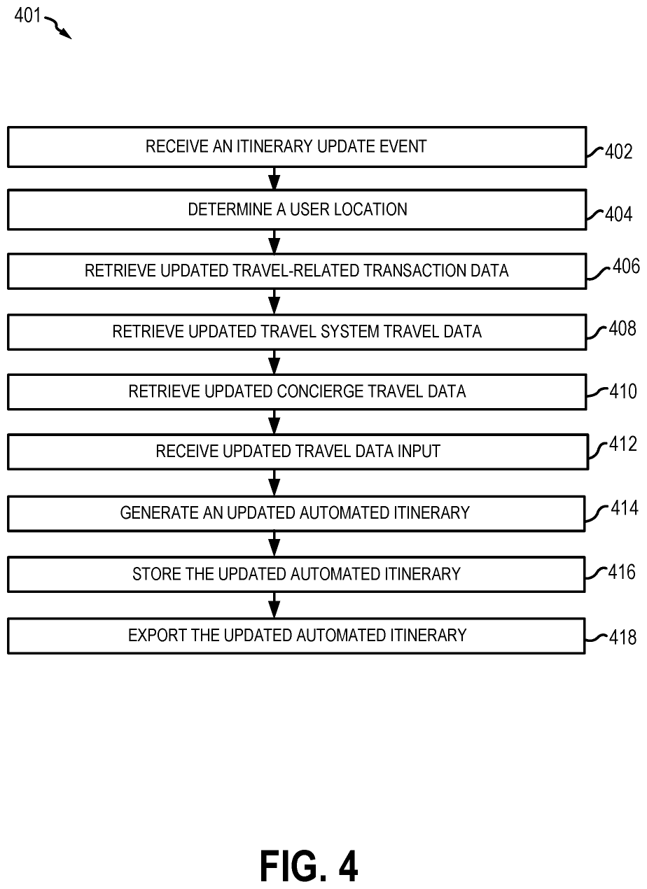

In various embodiments, and with specific reference to FIG. 4, a method 401 of updating an automated itinerary is disclosed. The system may receive an itinerary update event (step 402). For example, event aggregator system 114 may receive or detect the itinerary update event. Event aggregator system 114 may receive the itinerary update event from user device 110, via travel interface 112, in response to the user requesting an update to an automated itinerary. Event aggregator system 114 may also be configured to receive the itinerary update event based on an update time interval (e.g., 5 minutes, 1 hour, 1 day, etc.). In response to receiving the itinerary update event, event aggregator system 114 may be configured to retrieve various travel data updated since the generation of the automated itinerary.

The system may determine a user location (step 404). Travel interface 112 may determine the user location based on location services from user device 110, based on a manual input from the user via user device 110, and/or through any other suitable method. The user location data may comprise GPS coordinates, a city, a state, etc. In response to determining the user location, travel interface 112 may transmit the user location to event aggregator system 114. In that regard, the user location may be used by event aggregator system 114 to retrieve suggested travel data based on the user location (e.g., recommend a restaurant based on the user's location).

In response to receiving (or detecting) the itinerary update event, event aggregator system 114 may query itinerary database 126 to retrieve the user itinerary account associated with the user (e.g., based on user identifier), including the automated itinerary to be updated. The system may retrieve updated travel-related transaction data (step 406). For example, event aggregator system 114 may communicate with issuer system 118 to retrieve updated travel-related transaction data based on the user itinerary account (e.g., the issuer system user identifier). Event aggregator system 114 may retrieve the updated travel-related transaction data by retrieving only the travel-related transaction data created since the previous retrieval (e.g., only transactions completed since the automated itinerary was generated or last updated). Event aggregator system 114 may transmit the updated travel-related transaction data to itinerary database 126. Itinerary database 126 may store the updated travel-related transaction data with the user itinerary account.

The system may retrieve updated travel system travel data (step 408). Event aggregator system 114 may retrieve the updated travel system travel data from travel system 120, based on the user itinerary account (e.g., the travel system user identifier). Event aggregator system 114 may retrieve the updated travel system travel based on a user selection, a defined travel date range, and/or the like. Event aggregator system 114 may retrieve the updated travel system travel data by retrieving only the travel system travel data created since the previous retrieval (e.g., only the travel system travel data that has been updated since the automated itinerary was generated or last updated). Event aggregator system 114 may transmit the updated travel system travel data to itinerary database 126. Itinerary database 126 may store the updated travel system travel data with the user itinerary account.

The system may retrieve updated concierge travel data (step 410). Event aggregator system 114 may retrieve the updated concierge travel data from concierge system 122. The updated concierge travel data may comprise travel booking data generated by concierge system 122 in response to the user interacting with concierge system 122 to book travel, update a previously booked travel, and/or the like. Event aggregator system 114 may transmit the updated concierge travel data to itinerary database 126. Itinerary database 126 may store the updated concierge travel data with the user itinerary account.

The system may receive an updated travel data input (step 412). Event aggregator system 114 may receive the updated travel data input from user device 110, via travel interface 112. The updated travel data input may comprise travel-related data manually input by the user, including new travel data, updates to previously transmitted travel data, updates to travel data retrieved by the system from various sources, and the like. The updated travel data input may comprise, for example, a digital image of a receipt, travel document of the like; a manual input of travel via a keyboard or similar input device; an email address available for email scraping; and/or the like. In various embodiments, event aggregator system 114 may implement natural language processing, optical character recognition (OCR) software, and/or the like configured to parse and identify the data from the updated travel data input. Event aggregator system 114 may transmit the parsed updated travel data input to itinerary database 126. Itinerary database 126 may store the parsed updated travel data input with the user itinerary account.

The system may also retrieve suggested travel data based on the user's location, a profile score, or the like, as discussed further herein. For example, event aggregator system 114 may retrieve suggested updated travel data from social media platform 116, travel system 120, and/or concierge system 122. Suggested updated travel data may include itineraries shared by the user's social media followers that the user may also be interested in booking. Suggested updated travel data may also include suggested restaurants, hotel reservations, flights, travel experiences, and/or the like retrieved from travel system 120 based on the user location. Suggested updated travel data may also include data retrieved by concierge system 122, such as, for example, travel suggested by concierge system 122 during an interaction with the user.

The system may generate an updated automated itinerary (step 416). Event aggregator system 114 may generate the updated automated itinerary based on one or more of the updated travel-related transaction data, the updated travel system travel data, the updated concierge travel data, and/or the updated travel data input. For example, event aggregator system 114 may query itinerary database 126 to retrieve the various updated travel data associated with the user itinerary account. Itinerary database 126 may organize the various updated travel data by time, date, trip, and/or any other method of organization. Event aggregator system 114 may generate the updated automated itinerary using any suitable process. For example, the updated automated itinerary may comprise the various updated travel data based on date range, specified trip, or the like. For example, the updated automated itinerary may comprise a trip timeline including the various updated travel data ordered sequentially.

The system may store the updated automated itinerary (step 416). Event aggregator system 114 may transmit the updated automated itinerary to itinerary database 126. Itinerary database 126 may store the updated automated itinerary with the user itinerary account. The system may export the updated automated itinerary (step 418). Event aggregator system 114 may export the updated automated itinerary into any suitable file format or presentation. For example, event aggregator system 114 may generate and export the updated automated itinerary as a word document, a .PDF document, an XML file, an image file (e.g., .JPG, .PNG, etc.) or the like. Event aggregator system 114 may also be configured to display the updated automated itinerary to user device 110, via travel interface 112. Event aggregator system 114 may also transmit the updated automated itinerary to user device 110 via text message, email, push notification, a provided URL, or the like. Event aggregator system 114 may also transmit the updated automated itinerary directly to social media platform 116.

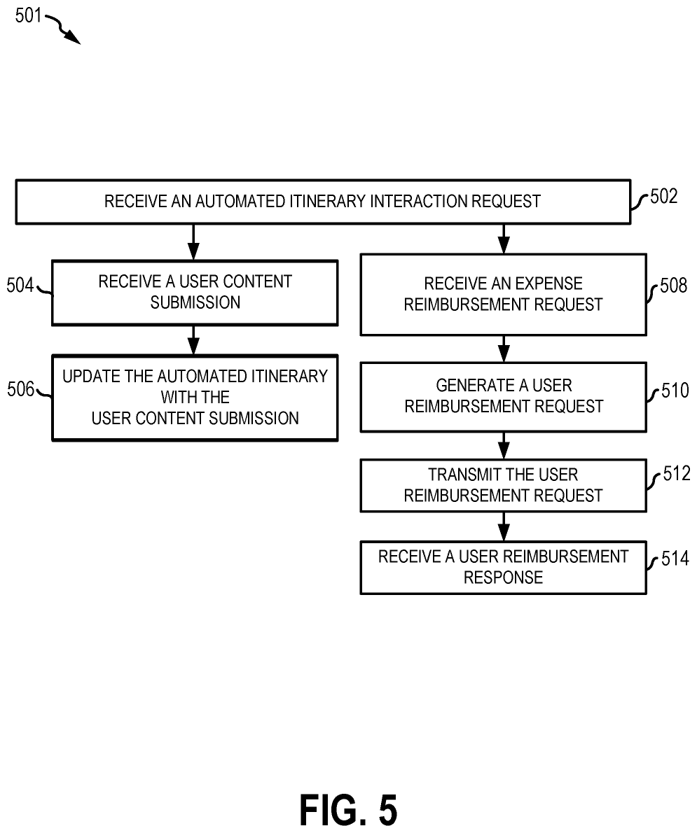

In various embodiments, and with specific reference to FIG. 5, a method 501 for interacting with automated itineraries is disclosed. The system may receive an automated itinerary interaction request (step 502). For example, a user may interact with travel interface 112 to transmit the automated itinerary interaction request. The automated itinerary interaction request may comprise a request to interact with an automated itinerary of a past, present, or future travel. In response to receiving the automated itinerary interaction request, travel interface 112 may transmit the automated itinerary interaction request to event aggregator system 114.

For example, the system may receive a user content submission (step 504). The user content submission may comprise a user image (e.g., a photograph, a digital image, a video, etc.), a user comment, a social media post, and/or the like. For example, a user may desire to upload the user content submission to customize the automated itinerary, such as by uploading a user image taken while on travel, a user image of a location the user desires to visit, or the like. The system may update the automated itinerary with the user content submission (step 506). For example, event aggregator system 114 may transmit the user content submission to itinerary database 126. Itinerary database 126 may store the user content submission in the user itinerary account associated with the automated itinerary. In various embodiments, wherein the user content submission comprises a time stamp (e.g., a date or time when a photo was taken), event aggregator system 114 may update the automated itinerary by inserting the time-stamped user content submission in chronological order in the automated itinerary. In various embodiments, users may share the automated itineraries with other users having access to the system. In that regard, the user content submission may also be received from a second user, such as, for example, in response to the second user commenting on the automated itinerary.

As a further example, the system may receive an expense reimbursement request (step 508). For example, a user, via user device 110, may access travel interface 112 to view an automated itinerary for past, present, or future travel. Travel interface 112, via event aggregator system 114 and itinerary database 126, may display transaction data from the automated itinerary. In that regard, the user may view the transaction data to determine expenses from the travel. The user may desire to seek reimbursement for one or more of the expenses from the travel, such as, for example, in response to the travel being for work, friends or family joining the travel, or the like. The user may interact with travel interface 112 to select the transactions the user desires to seek reimbursement for, to enter a reimbursement amount, and/or the like. The expense reimbursement request may also identify a second user (e.g., individual, entity, etc.) that the user desires to seek reimbursement from. For example, the second user may be identified based on a name, a transaction account identifier, or the like. In various embodiments, wherein the second user is registered for the system, the second user may also be identified via the second user's user identifier for the system. In response to receiving the expense reimbursement request, travel interface 112 may transmit the expense reimbursement request to event aggregator system 114.

As an example, a user may dine with a group of five friends and the user may pay the bill using his transaction account. The user may generate and transmit an expense reimbursement request to request one or more of the group of five friends to reimburse the user. The expense reimbursement request may comprise all or a portion of the transaction amount.

The system may generate a user reimbursement request (step 510). For example, in response to receiving the expense reimbursement request, event aggregator system 114 may generate the user reimbursement request. The user reimbursement request may comprise the reimbursement amount and the contact information of the second user. In various embodiments, in response to generating the user reimbursement request, event aggregator system 114 may transmit the user reimbursement request for storage in itinerary database 126. Itinerary database 126 may store the user reimbursement request with the user itinerary account, and may associate the user reimbursement request with the corresponding automated itinerary. In various embodiments, in response to generating the user reimbursement request, event aggregator system 114 may transmit the user reimbursement request to the second user. The user reimbursement request may be transmitted using any suitable communications channel, such as, for example, text message, email, mail, or the like.

The system may receive a user reimbursement response (step 514). For example, in response to the second user receiving and completing the user reimbursement request, event aggregator system 114 may receive the user reimbursement response. The user reimbursement response may comprise data indicating that the user reimbursement request was successfully completed. For example, in response to the second user having a transaction account at issuer system 118, issuer system 118 may transmit the user reimbursement response to event aggregator system 114. In response to receiving the user reimbursement response, event aggregator system 114 may transmit the user reimbursement response to itinerary database 126. Itinerary database 126 may store the user reimbursement response in the user itinerary account, and may associate with the user reimbursement response with the user reimbursement request and/or the automated itinerary from which the user reimbursement request originated.

In various embodiments, in response to receiving the user reimbursement response, event aggregator system 114 may also notify the user of the received response. For example, event aggregator system 114 may transmit the user reimbursement response to user device 110, directly or via travel interface 112.

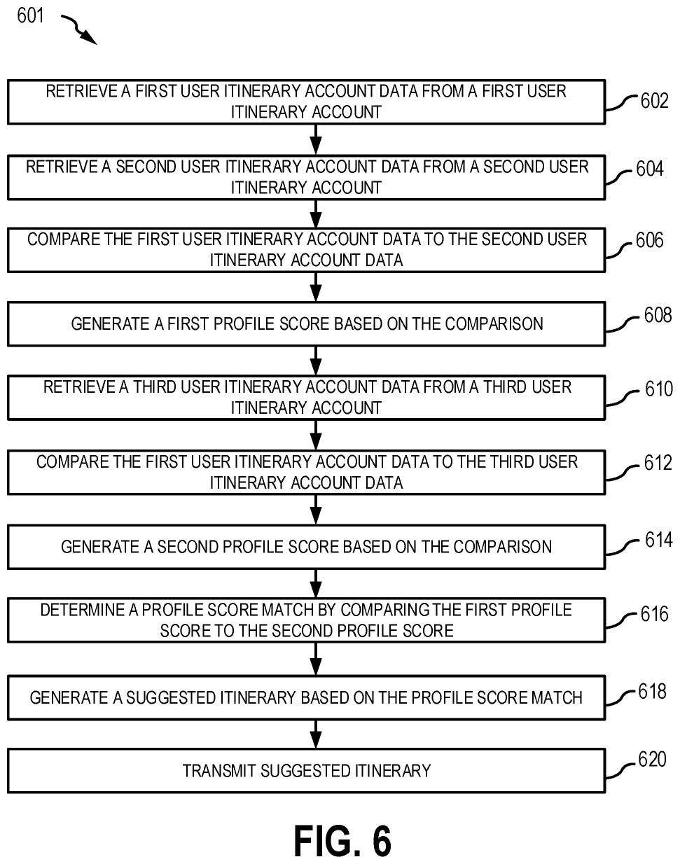

In various embodiments, and with specific reference to FIG. 6, a method 601 for calculating a profile score is disclosed. The system may retrieve a first user itinerary account data (step 602) from a first user itinerary account. Profile score system 124 may be configured to retrieve the first user itinerary account data from itinerary database 126. The system may retrieve a second user itinerary account data (step 604) from a second user itinerary account. Profile score system 124 may be configured to retrieve the second user itinerary account data from itinerary database 126.

The system may compare the first user itinerary account data to the second user itinerary account data (step 606). Profile score system 124 may be configured to compare the user itinerary account data using any suitable technique. For example, profile score system 124 may compare the user itinerary account data to determine an at least partial match between travel-related data. For example, profile score system 124 may determine common travel-related data between the user itinerary account data, such as, for example, similar trips, similar travel locations, and/or the like. As a further example, factors including trip location, restaurants, cuisine type, amount spent at restaurants, frequency of travel, transaction account type, cabin class, flight information, tour types, cruise type, trip hotel, hotel star number, and other factors may be compared when comparing the user itinerary data.

The system may generate a first profile score based on the comparison of the first user itinerary account data to the second user itinerary account data (step 608). Profile score system 124 may be configured to generate the first profile score. The first profile score may comprise a percent, or any other relational value, based on the comparison of the user itinerary data. In that regard, the first profile score may represent a similarity between the first user itinerary account and the second user itinerary account, wherein a high profile score indicates a high similarity, and a low profile score indicates a low similarity.

In various embodiments, the system may retrieve a third user itinerary account data (step 610) from a third user itinerary account. Profile score system 124 may be configured to retrieve the third user itinerary account data from itinerary database 126.

The system may compare the first user itinerary account data to the third user itinerary account data (step 612). Profile score system 124 may be configured to compare the user itinerary account data using any suitable technique, and similar to the comparison in step 606. For example, profile score system 124 may compare the user itinerary account data to determine an at least partial match between travel-related data. For example, profile score system 124 may determine common travel-related data between the user itinerary account data, such as, for example, similar trips, similar travel locations, and/or the like.

The system may generate a second profile score based on the comparison of the first user itinerary account data to the third user itinerary account data (step 614). Profile score system 124 may be configured to generate the second profile score similar to the generation of the first profile score in step 608. The second profile score may comprise a percent, or any other relational value, based on the comparison of the user itinerary data from the first user itinerary account and the third user itinerary account.

The system may determine a profile score match (step 616) by comparing the first profile score to the second profile score. For example, profile score system 124 may be configured to compare the first profile score to the second profile score to determine the score having the higher value. In various embodiments, profile score system 124 may also rank the profile scores sorted from high to low score. Profile score system 124 may return the profile score match and/or the sorted list of profile scores to user device 110, via event aggregator system 114 and travel interface 112.

The system may generate a suggested automated itinerary based on the profile score match (step 618). For example, in response to determining a profile score match, event aggregator system 114 may query itinerary database 126 to retrieve one or more automated itineraries from the user itinerary account associated with the matched profile score. Event aggregator system 114 may generate the suggested automated itinerary to comprise the retrieved automated itineraries, travel data from the retrieved automated itineraries, and/or the like.

The system may transmit the suggested automated itinerary (step 620). For example, event aggregator system 114 may transmit the suggested automated itinerary to user device 110, directly or via travel interface 112. In various embodiments, the user may view the suggested automated itinerary and choose to book travel or update present travel based on the suggested automated itinerary.

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Although specific advantages have been enumerated herein, various embodiments may include some, none, or all of the enumerated advantages.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy,” “meet,” “match,” “associated with”, or similar phrases may include an identical match, a partial match, meeting certain criteria, matching a subset of data, a correlation, satisfying certain criteria, a correspondence, an association, an algorithmic relationship, and/or the like. Similarly, as used herein, “authenticate” or similar terms may include an exact authentication, a partial authentication, authenticating a subset of data, a correspondence, satisfying certain criteria, an association, an algorithmic relationship, and/or the like.

Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input, and/or any other method known in the art.

As used herein, “transmit” may include sending at least a portion of electronic data from one system component to another. Additionally, as used herein, “data,” “information,” or the like may include encompassing information such as commands, queries, files, messages, data for storage, and the like in digital or any other form.

As used herein, “electronic communication” may comprise a physical coupling and/or non-physical coupling capable of enabling system components to transmit and receive data. For example, “electronic communication” may refer to a wired or wireless protocol such as a CAN bus protocol, an Ethernet physical layer protocol (e.g., those using 10BASE-T, 100BASE-T, 1000BASE-T, etc.), an IEEE 1394 interface (e.g., FireWire), Integrated Services for Digital Network (ISDN), a digital subscriber line (DSL), an 802.11a/b/g/n/ac signal (e.g., Wi-Fi), a wireless communications protocol using short wavelength UHF radio waves and defined at least in part by IEEE 802.15.1 (e.g., the BLUETOOTH® protocol maintained by Bluetooth Special Interest Group), a wireless communications protocol defined at least in part by IEEE 802.15.4 (e.g., the ZIGBEE® protocol maintained by the ZigBee alliance), a cellular protocol, an infrared protocol, an optical protocol, or any other protocol capable of transmitting information via a wired or wireless connection.

One or more of the system components may be in electronic communication via a network. As used herein, the term “network” may further include any cloud, cloud computing system, or electronic communications system or method that incorporates hardware and/or software components. Communication amongst the nodes may be accomplished through any suitable communication channels such as, for example, a telephone network, an extranet, an intranet, Internet, point of interaction device (personal digital assistant, cellular phone, kiosk, tablet, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using Internetwork Packet Exchange (IPX), APPLETALK® program, IP-6, NetBIOS, OSI, any tunneling protocol (e.g. IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the Internet is generally known to those skilled in the art and, as such, need not be detailed herein.

The various system components may be independently, separately or collectively suitably coupled to the network via data links which includes, for example, a connection to an Internet Service Provider (ISP) over the local loop as is typically used in connection with standard modem communication, cable modem, DISH NETWORKS®, ISDN, DSL, or various wireless communication methods. It is noted that the network may be implemented as other types of networks, such as an interactive television (ITV) network. Moreover, the system contemplates the use, sale or distribution of any goods, services or information over any network having similar functionality described herein.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, Triple DES, Blowfish, AES, MD5, HMAC, IDEA, RC6, and symmetric and asymmetric cryptosystems. Network communications may also incorporate SHA series cryptographic methods, elliptic-curve cryptography (e.g., ECC, ECDH, ECDSA, etc.), and/or other post-quantum cryptography algorithms under development.

For the sake of brevity, conventional data networking, application development, and other functional aspects of the system may not be described in detail herein. Furthermore, the connecting lines shown in the various figures contained herein are intended to represent exemplary functional relationships and/or electronic communications between the various elements. It should be noted that many alternative or additional functional relationships or electronic communications may be present in a practical system.

In various embodiments, user device 110 may integrate with one or more smart digital assistant technologies. For example, exemplary smart digital assistant technologies may include the ALEXA® system developed by the AMAZON® company, the GOOGLE HOME® system developed by Alphabet, Inc., the HOMEPOD® system of the APPLE® company, and/or similar digital assistant technologies. The ALEXA® system, GOOGLE HOME® system, and HOMEPOD® system, may each provide cloud-based voice activation services that can assist with tasks, entertainment, general information, and more. All the ALEXA® devices, such as the AMAZON ECHO®, AMAZON ECHO DOT®, AMAZON TAP®, and AMAZON FIRE® TV, have access to the ALEXA® system. The ALEXA® system, GOOGLE HOME® system, and HOMEPOD® system may receive voice commands via its voice activation technology, activate other functions, control smart devices, and/or gather information. For example, the smart digital assistant technologies may be used to interact with music, emails, texts, phone calls, question answering, home improvement information, smart home communication/activation, games, shopping, making to-do lists, setting alarms, streaming podcasts, playing audiobooks, and providing weather, traffic, and other real time information, such as news. The ALEXA®, GOOGLE HOME®, and HOMEPOD® systems may also allow the user to access information about eligible transaction accounts linked to an online account across all digital assistant-enabled devices.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, UNIX®, LINUX®, SOLARIS®, MACOS®, etc.) as well as various conventional support software and drivers typically associated with computers.

The present system, or any part(s) or function(s) thereof, may be implemented using hardware, software, or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by artificial intelligence (AI) or machine learning. Artificial intelligence may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

Any communication, transmission, communications channel, channel, and/or the like discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website, mobile application, or device (e.g., FACEBOOK®, YOUTUBE®, PANDORA®, APPLE TV®, MICROSOFT® XBOX®, ROKU®, AMAZON FIRE®, GOOGLE CHROMECAST™, SONY® PLAYSTATION®, NINTENDO® SWITCH®, etc.) a uniform resource locator (“URL”), a document (e.g., a MICROSOFT® Word™ or EXCEL®, an ADOBE® Portable Document Format (PDF) document, etc.), an “ebook,” an “emagazine,” an application or microapplication (as described herein), an SMS or other type of text message, an email, a FACEBOOK® message, a TWITTER® tweet, multimedia messaging services (MMS), and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network, and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, LINKEDIN®, INSTAGRAM®, PINTEREST®, TUMBLR®, REDDIT®, SNAPCHAT®, WHATSAPP®, FLICKR®, VK®, QZONE®, WECHAT®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

Further, illustrations of the process flows and the descriptions thereof may make reference to user WINDOWS® applications, webpages, websites, web forms, prompts, etc. Practitioners will appreciate that the illustrated steps described herein may comprise in any number of configurations including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS® applications but have been combined for simplicity.

In various embodiments, components, modules, and/or engines of system 100, or one or more subcomponents of system 100, may be implemented as micro-applications or micro-apps. Micro-apps are typically deployed in the context of a mobile operating system, including for example, a WINDOWS® mobile operating system, an ANDROID® operating system, an APPLE® iOS operating system, a BLACKBERRY® operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

In various embodiments, the system may implement middleware to provide software applications and services, and/or to bridge software components in the computer-based system, such as the operating system, database, applications, and the like. Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the internet server. Middleware may be configured to process transactions between the various components of an application server and any number of internal or external systems for any of the purposes disclosed herein. WEBSPHERE® MQ™ (formerly MQSeries) by IBM®, Inc. (Armonk, N.Y.) is an example of a commercially available middleware product. An Enterprise Service Bus (“ESB”) application is another example of middleware.

The systems, computers, computer-based systems, and the like disclosed herein may provide a suitable website or other internet-based graphical user interface which is accessible by users. Practitioners will appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT® programs, active server pages (ASP), common gateway interface scripts (CGI), extensible markup language (XML), dynamic HTML, cascading style sheets (CSS), AJAX (Asynchronous JAVASCRIPT and XML) programs, helper applications, plug-ins, and the like. A server may include a web service that receives a request from a web server, the request including a URL and an IP address (192.168.1.1). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. As a further example, representational state transfer (REST), or RESTful, web services may provide one way of enabling interoperability between applications.

In various embodiments, one or more servers discussed herein may include application servers (e.g., WEBSPHERE®, WEBLOGIC®, JBOSS®, POSTGRES PLUS ADVANCED SERVER®, etc.). In various embodiments, the server may include web servers (e.g. Apache, IIS, GOOGLE® Web Server, SUN JAVA® System Web Server, JAVA® Virtual Machine running on LINUX® or WINDOWS® operating systems, etc.).

Users, systems, computer-based systems or the like may communicate with the server via a web client. The web client includes any device or software which communicates via any network such as, for example any device or software discussed herein. The web client may include internet browsing software installed within a computing unit or system to conduct online transactions and/or communications. These computing units or systems may take the form of a computer or set of computers, although other types of computing units or systems may be used, including personal computers, laptops, notebooks, tablets, smart phones, cellular phones, personal digital assistants, servers, pooled servers, mainframe computers, distributed computing clusters, kiosks, terminals, point of sale (POS) devices or terminals, televisions, or any other device capable of receiving data over a network. The web client may include an operating system (e.g., WINDOWS®, WINDOWS MOBILE® operating systems, UNIX® operating system, LINUX® operating systems, APPLE® OS® operating systems, etc.) as well as various conventional support software and drivers typically associated with computers. The web-client may also run MICROSOFT® INTERNET EXPLORER® software, MOZILLA® FIREFOX® software, GOOGLE® CHROME® software, APPLE® SAFARI® software, or any other of the myriad software packages available for browsing the internet.

As those skilled in the art will appreciate, the web client may or may not be in direct contact with the server (e.g., application server, web server, etc., as discussed herein). For example, the web client may access the services of the server through another server and/or hardware component, which may have a direct or indirect connection to an internet server. For example, the web client may communicate with the server via a load balancer. In various embodiments, web client access is through a network or the internet through a commercially-available web-browser software package. In that regard, the web client may be in a home or business environment with access to the network or the internet. The web client may implement security protocols such as Secure Sockets Layer (SSL) and Transport Layer Security (TLS). A web client may implement several application layer protocols including HTTP, HTTPS, FTP, and SFTP.

Any databases discussed herein may include relational, hierarchical, graphical, blockchain, object-oriented structure, and/or any other database configurations. In various embodiments, any database may also include a no-SQL database, a key-value database, an in-memory database, a GPU database, and/or the like. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, N.Y.), various database products available from ORACLE® Corporation (Redwood Shores, Calif.), MICROSOFT ACCESS® or MICROSOFT SQL SERVER® by MICROSOFT® Corporation (Redmond, Wash.), MYSQL® by MySQL AB (Uppsala, Sweden), MONGODB®, Redis, Apache Cassandra®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); data stored as Binary Large Object (BLOB); data stored as ungrouped data elements encoded using ISO/IEC 7816-6 data elements; data stored as ungrouped data elements encoded using ISO/IEC Abstract Syntax Notation (ASN.1) as in ISO/IEC 8824 and 8825; other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored, may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user, or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer, may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the user at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers, or other components of the system may consist of any combination thereof at a single location or at multiple locations, wherein each database, system, device, server, and/or other component includes any of various suitable security features, such as firewalls, access codes, encryption, decryption, compression, decompression, and/or the like.

Encryption of data in system 100, including in one or more databases, may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, Triple DES, Blowfish, AES, MD5, HMAC, IDEA, RC6, and symmetric and asymmetric cryptosystems. The systems and methods may also incorporate SHA series cryptographic methods, elliptic-curve cryptography (e.g., ECC, ECDH, ECDSA, etc.), and/or other post-quantum cryptography algorithms under development.

A firewall may include any hardware and/or software suitably configured to protect CMS components and/or enterprise computing resources from users of other networks. Further, the firewall may be configured to limit or restrict access to various systems and components behind the firewall for web clients connecting through a web server. The firewall may reside in varying configurations including Stateful Inspection, Proxy based, access control lists, and Packet Filtering among others. The firewall may be integrated within a web server or any other CMS components or may further reside as a separate entity. The firewall may implement network address translation (“NAT”) and/or network address port translation (“NAPT”). The firewall may accommodate various tunneling protocols to facilitate secure communications, such as those used in virtual private networking. The firewall may implement a demilitarized zone (“DMZ”) to facilitate communications with a public network such as the internet. The firewall may be integrated as software within an internet server or any other application server components, reside within another computing device, or take the form of a standalone hardware component.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript, or the like. Cryptography and network security methods are well known in the art, and are covered in many standard texts.

In various embodiments, the software elements of the system may also be implemented using a JAVASCRIPT® run-time environment configured to execute JAVASCRIPT® code outside of a web browser. For example, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager such as, for example, Parallel Multithreaded Machine (“PM2”); a resource and performance monitoring tool such as, for example, Node Application Metrics (“appmetrics”); a library module for building user interfaces, and/or any other suitable and/or desired module.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet-based embodiment, an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, CD-ROM, SONY BLU-RAY DISC®, optical storage devices, magnetic storage devices, and/or the like.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method comprising:
receiving, by a processor, an itinerary generation event comprising instructions to generate an automated itinerary for a user itinerary account, wherein the user itinerary account is associated with a user transaction account;
retrieving, by the processor, transaction data from the user transaction account, wherein the transaction data is associated with a travel-based transaction; and
generating, by the processor, the automated itinerary, wherein the automated itinerary comprises the transaction data associated with the travel-based transaction.

2. The method of claim 1, further comprising:
retrieving, by the processor, at least one of travel system travel data or concierge travel data; and
generating, by the processor, the automated itinerary to comprise the at least one of the travel system travel data or the concierge travel data.

3. The method of claim 1, further comprising:
receiving, by the processor, a travel data input comprising a manual input of travel data; and
generating, by the processor, the automated itinerary to comprise the travel data input.

4. The method of claim 1, further comprising:
receiving, by the processor, an itinerary update event comprising instructions to update the automated itinerary;
retrieving, by the processor, updated transaction data from the user transaction account, wherein the updated transaction data is associated with a second travel-based transaction made after the travel-based transaction; and
updating, by the processor, the automated itinerary to comprise the updated transaction data.

5. The method of claim 4, further comprising:
retrieving, by the processor, at least one of updated travel system travel data or updated concierge travel data; and
updating, by the processor, the automated itinerary to comprise the at least one of the updated travel system travel data or the updated concierge travel data.

6. The method of claim 4, further comprising:
receiving, by the processor, an updated travel data input comprising a second manual input of travel data; and
updating, by the processor, the automated itinerary to comprise the updated travel data input.

7. The method of claim 1, further comprising:
receiving, by the processor, a user content submission, wherein the user content submission comprises at least one of an image or a user comment; and
updating, by the processor, the automated itinerary to comprise the user content submission.

8. The method of claim 1, further comprising:
receiving, by the processor, an expense reimbursement request, wherein the expense reimbursement request comprises a reimbursement value based on the transaction data and a second user;
transmitting, by the processor, the expense reimbursement request to the second user.

9. The method of claim 1, further comprising:
comparing, by the processor, the automated itinerary to a second automated itinerary;
generating, by the processor, a profile score based on the comparing; and
generating, by the processor, a suggested travel itinerary based on the profile score.

10. A system comprising:
a processor; and
a tangible, non-transitory memory configured to communicate with the processor, the tangible, non-transitory memory having instructions stored thereon that, in response to execution by the processor, cause the processor to perform operations comprising:
receiving, by the processor, an itinerary generation event comprising instructions to generate an automated itinerary for a user itinerary account, wherein the user itinerary account is associated with a user transaction account;
retrieving, by the processor, transaction data from the user transaction account, wherein the transaction data is associated with a travel-based transaction; and
generating, by the processor, the automated itinerary, wherein the automated itinerary comprises the transaction data associated with the travel-based transaction.

11. The system of claim 10, further comprising:
retrieving, by the processor, at least one of travel system travel data, concierge travel data, or a travel data input; and
generating, by the processor, the automated itinerary to comprise the at least one of the travel system travel data, the concierge travel data, or the travel data input.

12. The system of claim 10, further comprising:
receiving, by the processor, an itinerary update event comprising instructions to update the automated itinerary;
retrieving, by the processor, updated transaction data from the user transaction account, wherein the updated transaction data is associated with a second travel-based transaction made after the travel-based transaction; and
updating, by the processor, the automated itinerary to comprise the updated transaction data.

13. The system of claim 12, further comprising:
retrieving, by the processor, at least one of updated travel system travel data, updated concierge travel data, or an updated travel data input; and
updating, by the processor, the automated itinerary to comprise the at least one of the updated travel system travel data, the updated concierge travel data, or the updated travel data input.

14. The system of claim 10, further comprising:
receiving, by the processor, an automated itinerary interaction request, wherein the automated itinerary interaction request comprises at least one of a user content submission or an expense reimbursement request; and
updating, by the processor, the automated itinerary based on the user content submission or the expense reimbursement request.

15. The system of claim 10, further comprising:
comparing, by the processor, the automated itinerary to a second automated itinerary;
generating, by the processor, a profile score based on the comparing; and
generating, by the processor, a suggested travel itinerary based on the profile score.

16. An article of manufacture including a non-transitory, tangible computer readable storage medium having instructions stored thereon that, in response to execution by a computer-based system, cause the computer-based system to perform operations comprising:
receiving, by the computer-based system, an itinerary generation event comprising instructions to generate an automated itinerary for a user itinerary account, wherein the user itinerary account is associated with a user transaction account;
retrieving, by the computer-based system, transaction data from the user transaction account, wherein the transaction data is associated with a travel-based transaction; and
generating, by the computer-based system, the automated itinerary, wherein the automated itinerary comprises the transaction data associated with the travel-based transaction.

17. The article of claim 16, further comprising:
retrieving, by the computer-based system, at least one of travel system travel data, concierge travel data, or a travel data input; and
generating, by the computer-based system, the automated itinerary to comprise the at least one of the travel system travel data, the concierge travel data, or the travel data input.

18. The article of claim 16, further comprising:
receiving, by the computer-based system, an itinerary update event comprising instructions to update the automated itinerary;
retrieving, by the computer-based system, updated transaction data from the user transaction account, wherein the updated transaction data is associated with a second travel-based transaction made after the travel-based transaction; and
updating, by the computer-based system, the automated itinerary to comprise the updated transaction data.

19. The article of claim 18, further comprising:
retrieving, by the computer-based system, at least one of updated travel system travel data, updated concierge travel data, or an updated travel data input; and
updating, by the computer-based system, the automated itinerary to comprise the at least one of the updated travel system travel data, the updated concierge travel data, or the updated travel data input.

20. The article of claim 16, further comprising:
receiving, by the computer-based system, an automated itinerary interaction request, wherein the automated itinerary interaction request comprises at least one of a user content submission or an expense reimbursement request; and
updating, by the computer-based system, the automated itinerary based on the user content submission or the expense reimbursement request.
